(19) United States
(12) Patent Application Publication
(10) Pub. No.: US 2016/0203536 A1
(43) Pub. Date: Jul. 14, 2016

(54) DEDICATED ONLINE-RETAIL-SHOPPING SYSTEM AND METHOD

(71) Applicant: Pink Think, LLC, Birmingham, MI (US)

(72) Inventors: Cathy Termolle, Yonkers, NY (US); Susan Pyle, Wixom, MI (US); Lori Haddad, Birmingham, MI (US)

(21) Appl. No.: 14/594,412

(22) Filed: Jan. 12, 2015

(51) Int. Cl. G06Q 30/06; G06Q 30/02; G06Q 50/00

(52) U.S. Cl. CPC G06Q 30/0619; G06Q 30/0635; G06Q 50/01; G06Q 30/0214

(57) ABSTRACT

A dedicated online-retail-shopping system provides a first user thereof an option of shopping for a gift for a second user from at least one online retail store. The system includes a client computer system and a server computer system in communication with the client computer system over a computer network. The system provides the online retail store(s) capability of accessing a primary shopping website and joining the dedicated shopping as at least one respective affiliated store; provides the second user capability of accessing and joining the dedicated shopping, later accessing the website, directly linking to the affiliated store(s) that carries/carry items desired by the second user, and posting a wish list of at least one of the items desired by the second user as at least one respective gift on the website; provides the first user capability of accessing and joining the dedicated shopping, later accessing the website, and selectively extracting the wish list and information about the desired gift(s) from the website; allows the affiliated store(s) to directly fulfill the gifting; provides the second user capability of directly linking to the affiliated store(s), selecting the gift(s) from the website, and associating the gift(s) with a future date of delivery thereof to the first user; stores the information, delivery date, any special occasion, and delivery data into a database; secures payment for the gift(s); and delivers the gift(s) to the second user either by or on the delivery date.

### BACKGROUND OF INVENTION

1. Field of Invention

The invention relates, generally, to dedicated online-retail shopping and, more particularly, to a system and method for such shopping that combines individual “wish lists” (which are not specific to particular respective retailers and always accessible to and visible by the general public), direct links to respective retailers that carry desired items, direct fulfillment by the retailer(s), and one-stop shopping by individuals.

2. Description of Related Technology

A traditional brick-and-mortar retail store presents challenges to shopping for a shopper thereof—for example, insufficient amount of inventory; crowdedness; lengthy time of travel to and from the store, browsing within the store, checking-out of the store, and exchanging shopping items; ongoing decision-making (e.g., is a particular item worth it? . . . will it make a recipient thereof happy? . . . is it the right gift?); and issues related to store credit. Unfortunately, time is at a premium for the shopper.

Online retail shopping offers a faster solution to the retail shopper. However, there are unique issues associated with even this type of shopping. For instance, there is a timeline for delivery of an item, an item may not actually be as it is depicted online, and the shopper may need to visit multiple websites for him/her to find an item. Other such issues may involve shipping charges, shipping drop-off, and credit [i.e., 1) to whom credit is issued because often a return gift is credited to a gift-giver or gifter (not a recipient of the gift); or 2) for a particular online retailer, which may not be “style” of the recipient]. From a perspective of the online retailer, returned gifts can result in disappointed shoppers, decreased sales, restocking fees, decreased productivity of sales staff, and damaged items that cannot be re-sold.

Furthermore, each retail shopper has individual or personal desires and style and, thus, uniqueness such that no two shoppers want or need the same items. Also, it is a challenge for a shopper to find an ideal gift that communicates, say, thoughtfulness, sincerity, love, affection, and other characteristics associated with positive gifting. In this way, a recipient of the gift may not like or want the gift and, thus, return it, which return equates to lost time (a very precious commodity).

A prospective recipient of a gift may have his/her secret “wish list” of items that he/she desires or needs or to which the prospective gift recipient aspires to have. In this regard, each retail shopper (as a gifter) also needs to know at which retailer(s) the prospective gift recipient shops. General gift registries are directed toward satisfying this need, but tied to specific life-changing moments, such as anniversaries, graduation, marriage, etc.

Thus, there is still a need for a dedicated shopping website that combines individual “wish lists,” direct links to respective retailers that carry desired items, direct fulfillment by the retailer(s), and one-stop shopping by individuals. More specifically, there is a need for such “wish lists” that are not specific to particular respective retailers and always accessible to and visible by the general public.

### SUMMARY OF INVENTION

The invention satisfies these needs in a dedicated online-retail-shopping system and method. The system provides a first user thereof an option of shopping for at least one gift for a second user of the system from at least one affiliated online retail store. In a non-limiting exemplary embodiment of the system, the system provides at least one online retail store capability of accessing a primary shopping website of the system and joining the system as at least one respective affiliated store. The system provides the second user (hereinafter referred to merely as “the giftee”) capability of accessing the website and joining the system, later accessing the website, directly linking to the affiliated store(s) that carries/carry items desired by the giftee, and posting a wish list of at least one of the items desired by the giftee as at least one respective gift on the system. The system provides the first user (hereinafter referred to as “the gifter”) capability of accessing the website and joining the system, later accessing the website, and selectively extracting the wish list and information about the desired gift(s) from a page of the website. The system allows the affiliated store(s) to directly fulfill the gifting. The system provides the gifter capability of directly linking to the affiliated store(s), selecting the gift(s) from the website, and associating the gift(s) with a future date of delivery thereof to the giftee. The system stores the information, delivery date, any special occasion, and/or delivery data (such as name and address of the giftee) into a database; secures payment for the gift(s); and delivers the gift(s) to the giftee by or on the delivery date.

In aspects of this embodiment, the system is configured to allow the giftee to join the system by his/her logging into it to create a protected (for example, via a password) account of the giftee for the system. The account is configured to be linked to a predetermined means of communication of the giftee (for instance, an e-mail address of the giftee).

The giftee is allowed also to e-mail the wish list as he/she desires or needs to do so. Pertinent information related to the giftee and/or each item (e.g., size and shipping) is configured to be hidden such that only identity of the item is visible on the website to any third party. The system includes also an “invite a friend” function such that, when the giftee refers a third party to join the system and the third party joins and makes at least one purchase using the system, the giftee receives “points” that are redeemable toward purchase of at least one item and/or a cash gift toward a goal, such as a destination (trip or vacation). The giftee is allowed also to add at least one item desired by the giftee to the wish list (say, via a link-enabled connection). The system is configured also to be linked to at least one social-media site to which the giftee can post a link to his/her wish list.

The gifter is allowed to access the wish list through use by the gifter of a predetermined means of identification of the giftee (for example, name or e-mail address of the giftee). The gifter is allowed also to browse the wish list to find at least one item within, for instance, a budget of the gifter. The gifter is allowed also to select at least one particular item from the wish list for purchase thereof by the gifter and proceed to “check-out” for such purchase. The gifter is allowed also to select at “check-out,” say, gift-wrapping for the item(s), addition of a card for the giftee, and/or method of shipping of the item(s) to the giftee.

The system includes twenty-four-hour concierge service to handle any issues related to customer service by the system. The system is configured also to be used in connection with not only consumer goods, but services—e.g., those related to aesthetic treatments, auto repair, baby-sitting, banking, fitness clubs, house cleaning, massages, etc.—and funds (e.g., auto and college) as well. In this way, a mix of both cash toward a service or destination and consumer goods is allowed.

An advantage of the dedicated online-retail-shopping system and method according to the invention is that it is a dedicated shopping website that combines individual wish lists, direct links to respective retailers that carry desired items, direct fulfillment by the retailer(s), and one-stop shopping by individuals.

Another advantage of the dedicated online-retail-shopping system and method of the invention is that the wish lists are not specific to particular respective retailers.

Another advantage of the dedicated online-retail-shopping system and method of the invention is that the wish lists are always accessible to and visible by the general public.

Another advantage of the dedicated online-retail-shopping system and method of the invention is that it saves a premium commodity of the shopper . . . time.

Another advantage of the dedicated online-retail-shopping system and method of the invention is that it is personalized and allows for individual desires of each of the giftee, gifter, and retailer to be satisfied.

Another advantage of the dedicated online-retail-shopping system and method of the invention is that it transcends retail shopping from ordinary to luxurious.

Another advantage of the dedicated online-retail-shopping system and method of the invention is that it reduces or even eliminates downsides of gift-giving.

Another advantage of the dedicated online-retail-shopping system and method of the invention is that it reaches target audiences of all ages and income (household and individual).

Another advantage of the dedicated online-retail-shopping system and method of the invention is that it provides virtual retail-shopping therapy (allowing the giftee to indulge in selecting items that he/she desires without actually making any purchases).

Another advantage of the dedicated online-retail-shopping system and method of the invention is that it allows for “guilt-free” retail shopping.

Another advantage of the dedicated online-retail-shopping system and method of the invention is that it allows perfect gift-giving in just a few clicks.

Another advantage of the dedicated online-retail-shopping system and method of the invention is that it allows the gifter to pay immediately when he/she selects a gift for the giftee.

Another advantage of the dedicated online-retail-shopping system and method of the invention is that it allows the gifter to pay at a predetermined future time prior to a date of delivery of the gift to the giftee.

Another advantage of the dedicated online-retail-shopping system and method of the invention is that it provides the giftee capability of creating the wish lists and sending them to potential gifters.

Another advantage of the dedicated online-retail-shopping system and method of the invention is that it provides a gifter ability to provide a gift card to a giftee.

Another advantage of the dedicated online-retail-shopping system and method of the invention is that it reminds the gifter of special occasions resulting in his/her never missing any of them.

Another advantage of the dedicated online-retail-shopping system and method of the invention is that it allows the gifter to not second-guess desires of the giftee when the gifter cannot easily reach the giftee such that contact between them is limited.

Those having ordinary skill in the related technology should readily appreciate objects, features, and advantages of the dedicated online-retail-shopping system and method of the invention as it becomes more understood while the subsequent detailed description of a non-limiting exemplary embodiment of the system and method is read taken in conjunction with an accompanying drawing thereof.

### BRIEF DESCRIPTION OF EACH FIGURE OF DRAWING OF INVENTION

FIG. 1 is a block diagram showing a non-limiting exemplary embodiment of a conventional client/server-environment configuration to support a dedicated online-retail-shopping system and method according to the invention;

FIG. 2 is a block diagram showing various software components implemented upon the conventional client/server-environment configuration illustrated in FIG. 1;

FIG. 3 is a block diagram showing steps of gifting of an item from a gifter to a giftee according to a non-limiting exemplary embodiment of the dedicated online-retail-shopping system and method of the invention;

FIG. 4 is a block diagram showing sample shopping categories and types of product of interest available as respective items for possible gifting according to the embodiment of the dedicated online-retail-shopping system and method of the invention illustrated in FIG. 3; and

FIG. 5 is a block diagram showing general shopping and shipping protocols according to the embodiment of the dedicated online-retail-shopping system and method of the invention illustrated in FIG. 3.

### DETAILED DESCRIPTION OF EXEMPLARY EMBODIMENT OF INVENTION

Referring to the figures, throughout which like numerals are used to designate like structure, a dedicated online-retail-shopping system according to the invention, in various aspects of a non-limiting exemplary embodiment thereof, is generally indicated at 10. It should be readily appreciated by those having ordinary skill in the related technology that, although the system 10 is disclosed herein as being implemented in connection with retail shopping, the system 10 can be employed with any suitable type of non-retail shopping as well.

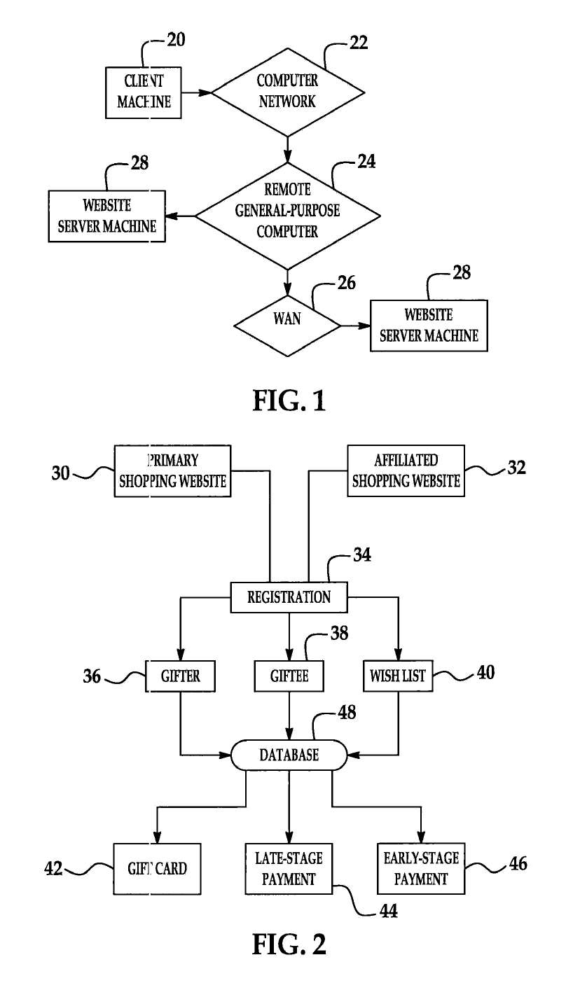

Referring now specifically to FIG. 1, a block diagram shows a non-limiting exemplary embodiment of a conventional client/server-environment configuration to support the system 10. A client machine 20—such as a conventional local personal computer including an operating system (e.g., Windows®)—is configured to support application protocols [i.e., HTTP (Hypertext Transfer Protocols)] of a computer network known as “the WorldWide Web” (WWW) (referred to hereinafter as merely “the web”) portion of the Internet. A URL (Uniform Resource Locator) is a web address used with the HTTP.

It should be readily appreciated by those having ordinary skill in the related art that the application protocols can be supported by any suitable client machine. It should be so appreciated also that the local personal computer can include any suitable operating system. It should be so appreciated also that the client machine 20 can be configured to support any suitable application protocols.

The local computer 20 is equipped with a screen display and at least one input/output device—for example, a keyboard, mouse, or voice-activated control—through which a user of the local computer 20 interacts with the local computer 20. The local computer 20 is also operatively connected to the Internet and/or an intranet or another computer network 22 via a modem, “T1” line, DSL (Digital Subscriber Line), or another suitable high-speed-line connection. It should be readily appreciated by those having ordinary skill in the related art that the local computer 20 can be equipped with any suitable input/output device.

The computer network 22 can include a remote general-purpose computer 24 that provides an interface to a WAN (Wide Area Network) 26 that interfaces. More specifically, the general-purpose computer 24 is operatively connected to the computer network 22 via a modem, “T1” Line, DSL, or another suitable high-speed-line connection. In an aspect of the embodiment, the general-purpose computer 24 is an Internet-based web server or gateway 24 connected to the computer network 22. The server 24 is equipped with a screen display and user-input/-output device through which an administrator interacts with at least one computer on the Internet that can be categorized as a website server machine 28. Each server machine 28 implements and supports a primary shopping website and at least one affiliated or secondary shopping website each of which includes various web pages to which the local computer 20 may connect. Generally, there are a plurality of affiliated websites. The local computer 20 communicates with the server machine 28 over the web, and the server machine 28 provides services to the local computer 20 over the Internet.

A third-party online-retail outlet or store can become affiliated with a shopping software application (for example, a “Wishful Thinking” application) stored on the server machine 28. (It should be readily appreciated by those having ordinary skill in the related art that the shopping software application can have any suitable name.) The application on the server machine 28 includes several modules implemented using “HTML” (HyperText Mark-up Language) document language and an “ASP” (Active Server Pages) software environment. HTML is the mark-up language that is used to describe to the browser how to display text included in the web pages. Webpage information is captured from a server of the affiliated store via a proxy or tool-bar process in a manner known in the related art. In this way, a transparent and seamless interface is used to capture the information from the affiliated store and then transfer page-structure information to the “Wishful Thinking” application.

The local computer 20 is configured to run software that includes a web browser for retrieving electronic documents from the server machine 28 for display of the documents on the local computer 20. Conventional browser software includes Internet Explorer® and Netscape Navigator®, and conventional ISP (Internet Service Provider) software includes AOL® and Yahoo®.

A first user or shopper (referred to hereinafter as “the gifter”) accesses through the browser the “Wishful Thinking” application stored on the server machine 28. The “ASP” software environment is configured for receiving and responding to requests by the gifter to the server machine 28.

In an aspect, the gifter enters a URL (for instance, “www.wishfulthinking com”) through the browser to access a home page of a corresponding primary “Wishful Thinking” shopping website. (It should be readily appreciated by those having ordinary skill in the related art that the gifter can enter any suitable URL.) Once the gifter enters the URL, the browser sends a request to the server machine 28 to retrieve the home page. The response by the server machine 28 includes a website-page form or structure that is static or interactive. Once the website-page structure is sent by the server machine 28, the browser displays the home page to the gifter by executing the “HTML” document language. Once at the “Wishful Thinking” website, as described in detail below, the gifter has the option of shopping for at least one item on a wish list of a potential second user or recipient of the item (referred to hereinafter as “the giftee”) and selecting the item as a gift. Generally, there are a plurality of items on the wish list, and the gifter can select several of the items as respective gifts. Also as described below, the gifter has the options of entering an early- or a late-stage-shopping payment protocol.

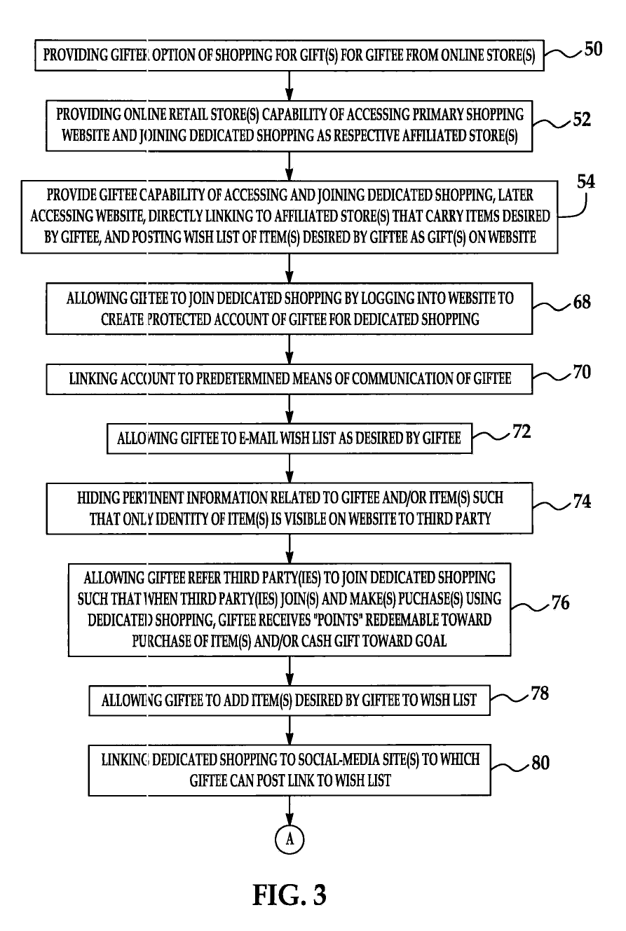

Referring now specifically to FIG. 2, a block diagram shows various software components of the system 10 implemented upon the conventional client/server-environment configuration (i.e., the server machine 28 and modules). For the system 10 to provide the gifter the option of shopping for the gift for the giftee from at least one affiliated store (generally, there are a plurality of such stores), the “Wishful Thinking” website 30 generates page structures to support the shopping protocol for the gift from this single website 30. The system 10 provides a direct link to the affiliated store that carries the desired gift. As such, an affiliated shopping website 32 generates page structures to support shopping for the gift on the corresponding affiliated store and links to a main application process via a proxy process (i.e., linking the affiliated website 32 to the main application process) or tool bar.

Registration 34 supports page structures for registration of the giftee, gifter, and affiliated store with the system 10 as respective members of the system 10. A “Gifter” module 36 supports page structures for managing a relationship between the gifter and giftee. A “Giftee” module 38 supports page structures for managing the giftee. A “Wish List” module 40 supports page structures for allowing the giftee to create a wish list of identified desired gifts. A “Gift Card” module 42 supports page structures for paying of the gift by the gifter via a gift card. A “Late-Stage Payment” module 44 supports page structures for paying of the gift by the gifter at some predetermined future time before shipment of the gift to the giftee. An “Early-Stage payment” module 46 supports page structures for paying of the gift by the gifter immediately. A “Database” Module 48 includes database-table structures for supporting contact information and types (e.g., “gifter” and “giftee,” “gifter” only, “giftee” only, etc.), information about the gift, gifter/giftee relationship, giftee/occasion relationship, giftee/occasion/gift relationship, recurring giftee/occasion/gift relationship, wish lists, and wish list/gift relationship. It should be readily appreciated by those having ordinary skill in the related art that the database-table structures can support any suitable types.

It should be readily appreciated by those having ordinary skill in the related art that the system 10 can be supported by any suitable client/server-environment configuration. It should be so appreciated also that any suitable software components can be implemented upon the suitable client/server-environment configuration.

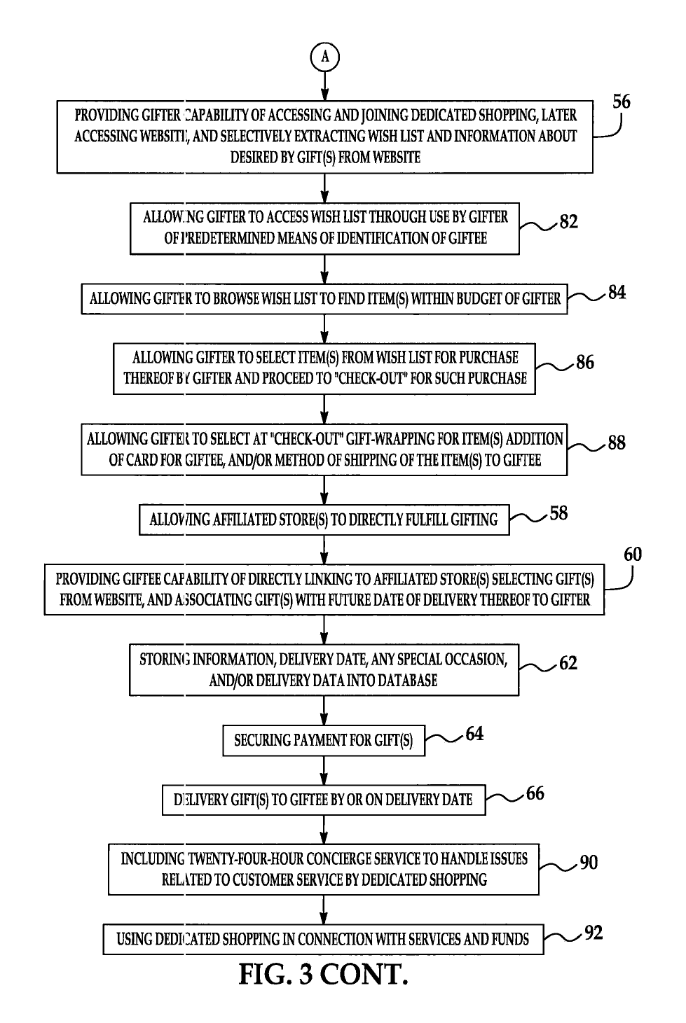

Referring now specifically to FIG. 3, a block diagram shows steps of the gifting from the gifter to the giftee according to the system 10. A dedicated online-retail-shopping method, according to the invention, in various aspects of a non-limiting exemplary embodiment thereof, is generally indicated at 50, whereby the gifter is provided the option of shopping for the gift(s) for the giftee from the online retail store(s). In the method 50, the system 10 is configured to provide the giftee, gifter, and affiliated store capability of performing certain acts, and the system 10 is configured also to automatically perform certain acts in anticipation or response to the acts of the giftee, gifter, and affiliated store and in conjunction therewith.

In general, at step 52a, the online retail store(s) can access the “Wishful Thinking” website 30. At step 52b, the online retail store(s) can join the system 10 as at least one respective affiliated store. At step 54a, the giftee can access the website 30. At step 54b, the giftee can join the system 10. At step 54c, the giftee can later access the website 30. At step 54d, the giftee can directly link to the affiliated store(s) that carry items desired by the giftee. At step 54e, the giftee can post a wish list of at least one of the items desired by the giftee as at least one respective gift on the system 10. At step 56a, the gifter can access the website 30. At step 56b, the gifter can join the system 10. At step 56c, the gifter can later access the website 30. At step 56d, the gifter can selectively extract the wish list from a page of the website 30. At step 56e, the gifter can selectively extract information about the desired gift(s) from a page of the website 30. At step 58, the system 10 allows the affiliated store(s) to directly fulfill the gifting. At step 60a, the gifter can directly link to the affiliated store(s). At step 60b, the gifter can select the gift(s) from the website 30. At step 60c, the gifter can associate the gift(s) with a future date of delivery thereof to the giftee. At step 62, the system 10 stores the information, delivery date, any special occasion, and/or delivery data (such as name and address of the giftee) into the database 48. At step 64, the system 10 secures payment for the gift(s). At step 66, the system 10 delivers the gift(s) to the giftee by or on the delivery date.

More specifically, in aspects of this embodiment, the system 10 is configured to, at step 68, allow the giftee to join the system 10 by his/her logging into the system 10 to create a protected (for example, via a password) account of the giftee for the system 10 (for example, via a password). At step 70, the account is also configured to be linked to a predetermined means of communication of the giftee (for instance, an e-mail address of the giftee).

It should be readily appreciated by those having ordinary skill in the related art that the system 10 can be configured to allow the giftee to join the system 10 in any suitable manner. It should be so appreciated also that the account can be protected via any suitable manner. It should be so appreciated also that the account can be configured to be linked to any suitable predetermined means of communication of the giftee.

At step 72, the giftee is allowed also to e-mail the wish list as he/she desires or needs to do so. At step 74, pertinent information related to the giftee and/or each item (e.g., size and shipping) is configured to be hidden such that only identity of the item is visible on the website to any third party. At step 76, the system 10 includes also an “invite a friend” function such that, when the giftee refers a third party to join the system 10 and the third party joins and makes at least one purchase using the system 10, the giftee receives “points” that are redeemable toward purchase of at least one item and/or a cash gift toward a goal, such as a destination (trip or vacation). At step 78, the giftee is allowed also to add at least one item desired by the giftee to the wish list (say, via a link-enabled connection). At step 80, the system 10 is configured also to be linked to at least one social-media site to which the giftee can post a link to his/her wish list.

It should be readily appreciated by those having ordinary skill in the related art that any information can be configured to be hidden such that only identity of the item is visible to any third party. It should be so appreciated also that the giftee can receive “points” that are redeemable toward purchase of an item or a cash gift toward any suitable goal. It should be so appreciated also that the giftee can be allowed to add the item(s) desired by the giftee to the wish list via any suitable manner. It should be so appreciated also that the system 10 can be configured to be linked to any suitable social-media site.

At step 82, the gifter is allowed to access the wish list through use by the gifter of a predetermined means of identification of the giftee (for example, name or e-mail address of the giftee). At step 84, the gifter is allowed also to browse the wish list to find at least one item within, for instance, a budget of the gifter. At step 86, the gifter is allowed also to select at least one particular item from the wish list for purchase thereof by the gifter and proceed to “check-out” for such purchase. At step 88, the gifter is allowed also to select at “check-out,” say, gift-wrapping for the item(s), addition of a card for the giftee, and/or method of shipping of the item(s) to the giftee.

It should be readily appreciated by those having ordinary skill in the related art that the gifter can be allowed to access the wish list through use by the gifter of any suitable means of identification of the giftee. It should be so appreciated also that the gifter can be allowed to browse the wish list to find an item within any suitable range of any suitable parameter. It should be so appreciated also that the gifter can be allowed to make any suitable selection at “check-out.”

At step 90, the system includes twenty-four-hour concierge service to handle any issues related to customer service by the system. At step 92, the system is configured also to be used in connection with not only consumer goods, but services—e.g., those related to aesthetic treatments, auto repair, baby-sitting, banking, fitness clubs, house cleaning, massages, etc.—and funds (e.g., auto and college) as well. In this way, a mix of both cash toward a service or destination and consumer goods is allowed.

It should be readily appreciated by those having ordinary skill in the related art that the concierge service can be configured to handle any issues related to the system 10. It should be so appreciated also that the system 10 can be configured to be used in connection with any suitable goods, services, and funds.

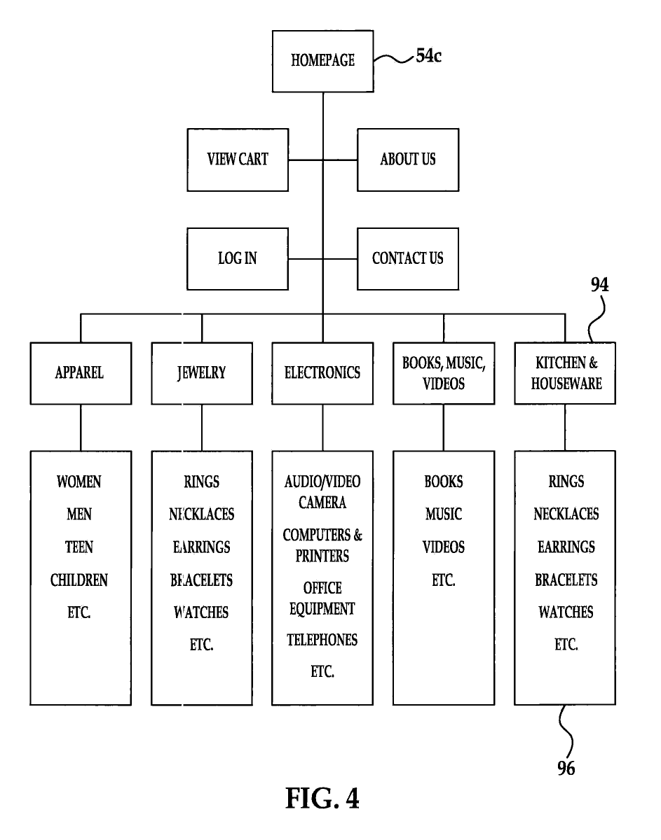

Referring now specifically to FIG. 4, a block diagram shows sample shopping categories and types of product of interest available as respective items for possible gifting in the system 10 and method 50. Once the giftee enters the home page of the website 30 and logs into the system 10, at step 94, the giftee can select a shopping category (e.g., apparel, electronics, jewelry, etc.). At step 96, the giftee can select a gift from a particular shopping category. Gift information can be transferred to a server program for storage within the database 48. The gifter can select a desired giftee. For the selected giftee, a “giftee” data file can be displayed, and the gifter can be allowed to enter shipping information. The database 48 can be monitored to determine gifts that are within a predetermined amount of time of shipment (say, one month), and a “reminder” message can be sent to the gifter. If gifts are within a lesser predetermined amount of time (say, one week) of shipment, an ordering protocol can be entered. If the gift is not available any longer, a next choice can be retrieved from the wish list. If no gift choice is available, a gift certificate can be sent to the giftee. A message confirming purchase of the gift certificate for the giftee can be sent to the gifter.

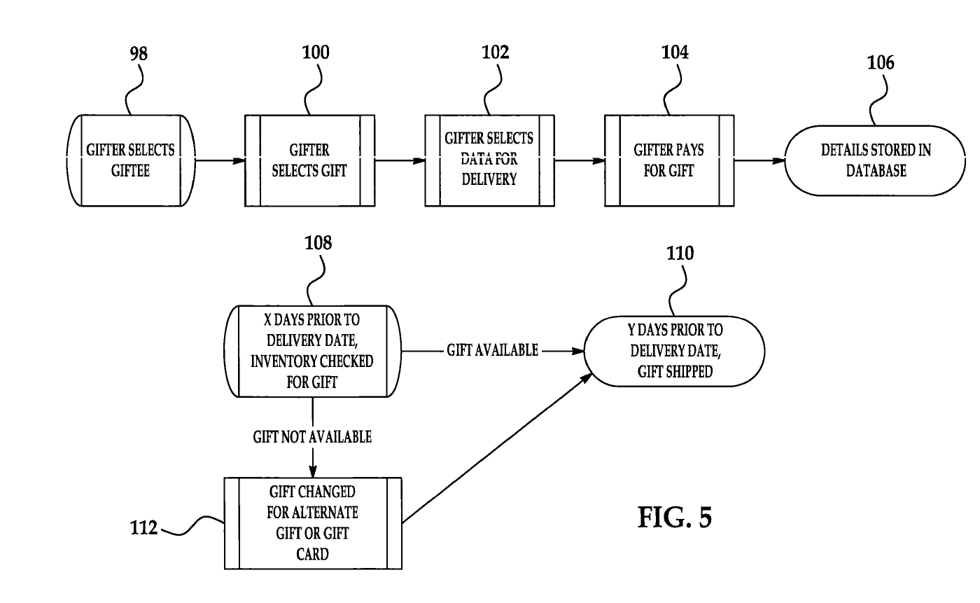

Referring now specifically to FIG. 5, a block diagram shows general shopping and shipping protocols according to the system 10 and method 50. After the gifter selects the gift for the giftee from the website 30, the gift information is captured from the page and the “Wishful Thinking” application process is initiated. In this initiation, at step 98, the gifter is prompted to select the giftee. At step 100, the gifter is prompted to select the gift. At step 102, the gifter selects a date for delivery of the gift. At step 104, the gifter pays for the gift immediately or at some future time. Then, at step 106, details are stored in the database 48. On a recurring basis, via a batch process on the server machine 28, delivery of the gift is initiated. Toward that end, a delivery date of the gift is checked in the database 48. In this initiation, if the gift is scheduled for delivery on a specific date to the giftee, availability of the gift is determined. More specifically, at step 108, a predetermined number of days (X) prior to the delivery date, inventory is checked for the availability of the gift. If the gift is available, the corresponding affiliated store is notified to ship the gift to the giftee. At step 110, a predetermined number of days (Y) prior to the delivery date, the gift is shipped. However, if the gift is not available, at step 112, the gift is changed for an alternate gift or a gift card.

In other aspects of the embodiment or respective versions of the aspects described above, an early-stage-payment shopping protocol can include a new member (a prospective gifter or giftee) of the system 10 selecting, for example, “new member.” In this case, contact information of the new member is obtained, and the information is registered with the database 48. The new member is provided the options of creating a new giftee, new gifter, new wish list, and/or gift without a giftee. The new member is prompted for the information, and the information is stored in the database 48. Then, the new member is provided the option of continuing to shop at the affiliated store or website.

In the case of the new or an existing member being a giftee, the giftee is allowed to create a wish list and associate information about a potential gift with the wish list. The giftee is prompted to enter information about an occasion and provide a name for the wish list. The gift information is stored in a database table, and the wish-list name associated with the gift information is stored in the table. Then, the giftee is provided the option of continuing to shop at the affiliated store or website.

The member is provided the option of storing gift information without a giftee. More specifically, the gift information is stored within a table identifying the gift to be assigned to a giftee at a future date. Then, the member is provided the option of continuing to shop at the affiliated store or website. Alternatively, the member is provided the option of registering a new giftee. Information about the giftee is stored within the database 48. The member is allowed to select an occasion.

If the member is not already logged into the system 10, the system 10 provides the member the option of logging into the system 10. After logging into the system 10 as a member, the member is provided the option of selecting a gifter or giftee, creating a new gifter/giftee, or storing information about the gift(s) to be assigned.

The system 10 allows the member to create a new wish list or access an existing wish list to associate the selected gift information with the newly created or existing wish list. If the member selects an existing wish list, the system 10 stores the information into the existing wish list. Then, the member is provided the option of continuing to shop at the affiliated store or website.

If the member is already logged into the system 10, the system 10 provides the member the option of selecting “wish list,” “gifter,” or “giftee.” If the member selects “wish list,” the member stores a gift with a wish list and continue shopping. If the member selects “gifter,” the system 10 makes an entry into a “gifter/giftee” table, stores a gift into a “gifts to be assigned” table, and a message is sent to the member. The system 10 then continues shopping. If the member selects “giftee,” the system 10 prompts the member to select an occasion, create a new occasion, or store a gift without an occasion.

If the member selects the option of creating a new occasion, the system 10 prompts the member to enter information about the occasion. The system 10 stores the information into the database 48 and can obtain the information. If the member selects the option of a new or an existing occasion from the database 48, the system 10 allows the member to schedule the occasion as a recurring or one-time event. The system 10 provides the member the option of delivering a gift to the giftee on a recurring or one-time basis. If the member wants to store the gift without a specific occasion, the system 10 stores the information into the “gifts to be assigned” table. Then, the system 10 allows the member to continue shopping.

In securement of payment by the system 10, if the member uses a gift card, the system 10 processes the gift card. More specifically, an amount of a purchase is set to pending for payment. The system 10 determines whether there is a sufficient amount of credit on the gift card to cover the purchase amount. If there is such amount, the system 10 determines whether the gift card is unrestricted or restricted. If the gift card is unrestricted, a message is sent to the gifter with the wish list. However, if the gift card is restricted, the member is reminded that the gifter must approve the purchase.

Alternatively, if the member uses a credit card, obtainment of credit-card authorization is attempted. Once payment is successful, the system 10 determines whether the delivery date is immediate or not. The credit-card transaction can be voided if the delivery date is, say, two weeks from the current date. A credit-card-authorization code is stored in the database 48.

In securement of shipping by the system 10, the system 10 cycles through a queue of gifts and determines whether a particular original gift is due to be delivered within a predetermined period of time (e.g., two weeks). If the gift is available within the inventory, the system 10 secures payment, the gift is shipped, and a notification is sent to the member. If the gift is not available within the inventory, the system 10 proceeds to a next gift on the wish list until a new gift is found that is available within the inventory and retails for substantially the same price as does the original gift. If the newly found gift retails for lesser of a price than does the original gift, the system 10 creates a gift card. If the newly found gift retails for greater of a price than does the original gift, the system 10 collects the difference between the respective retail prices. If the wish list is exhausted, the system 10 creates a new gift card and contacts the member.

The system 10 is a dedicated shopping website that combines individual wish lists, direct links to respective online retailers that carry desired items, direct fulfillment by the retailer(s), and one-stop shopping by individuals. Also, the wish lists are not specific to particular respective retailers and are always accessible to and visible by the general public. And, the system 10 saves a premium commodity of the shopper . . . time. Furthermore, the system 10 is personalized and allows for individual desires of each of the giftee, gifter, and retailer to be satisfied. In addition, the system 10 transcends retail shopping from ordinary to luxurious. Moreover, the system 10 reduces or even eliminates downsides of gift-giving. Plus, the system 10 reaches target audiences of all ages and income (household and individual).

The system 10 provides retail-shopping therapy and allows for “guilt-free” retail shopping and perfect gift-giving in just a few clicks. Also, the system 10 allows the gifter to pay immediately when he/she selects a gift for a giftee. And, the system 10 allows the gifter to pay at a predetermined future time prior to the date of the delivery of the gift to the giftee. Furthermore, the system 10 provides the giftee capability of creating the wish lists and sending them to potential gifters. In addition, the system 10 provides the gifter ability to provide a gift card to the giftee as well. Moreover, the system 10 reminds the gifter of special occasions resulting in his/her never missing any of them. Plus, the system 10 allows the gifter to not second-guess desires of the giftee when the gifter cannot easily reach the giftee such that contact between them is limited.

The system 10 and method 50 have been described above in an illustrative manner. Those having ordinary skill in the related technology should readily appreciate that the terminology that has been used above is intended to be in the nature of words of description rather than of limitation. Many modifications and variations of the system 10 and method 50 are possible in light of the above teachings. Therefore, within the scope of the claims appended hereto, the system 10 and method 50 may be practiced other than as so described.

What is claimed is:

1. A method of dedicated online retail shopping using a client computer system in communication with a server computer system over a computer network, the method providing a first user of the dedicated shopping an option of shopping for at least one gift for a second user of the dedicated shopping from at least one online retail store and comprising steps of:
providing the online retail store capability of accessing a primary shopping website and joining the dedicated shopping as an affiliated store;
providing the second user capability of accessing and joining the dedicated shopping, later accessing the website, directly linking to the affiliated store that carries items desired by the second user, and posting a wish list of at least one item desired by the second user as a gift on the website;
providing the first user capability of accessing and joining the dedicated shopping, later accessing the website, and selectively extracting the wish list and information about the desired gift from the website;
allowing the affiliated store to directly fulfill the gifting;
providing the second user capability of directly linking to the affiliated store, selecting the gift from the website, and associating the gift with a future date of delivery thereof to the first user;
storing at least one of the information, delivery date, any special occasion, and delivery data into a database;
securing payment for the gift; and
delivering the gift to the second user either of by and on the delivery date.

2. The method of dedicated online retail shopping as set forth in claim 1, wherein the method comprises further a step of allowing the second user to join the dedicated shopping by logging into the website to create a protected account of the second user for the dedicated shopping.

3. The method of dedicated online retail shopping as set forth in claim 1, wherein the method comprises further a step of allowing the second user to refer at least one third party to join the dedicated shopping such that when the third party joins and makes at least one purchase using the dedicated shopping, the second user receives at least one of “points” redeemable toward purchase of at least one of the items and a cash gift toward a goal.

4. The method of dedicated online retail shopping as set forth in claim 1, wherein the method comprises further a step of allowing the second user to add at least one item desired by the second user to the wish list.

5. The method of dedicated online retail shopping as set forth in claim 1, wherein the method comprises further a step of linking the dedicated shopping to at least one social-media site to which the second user can post a link to the wish list.

6. The method of dedicated online retail shopping as set forth in claim 1, wherein the method comprises further a step of allowing the first user to access the wish list through use by the first user of a predetermined means of identification of the second user.

7. The method of dedicated online retail shopping as set forth in claim 1, wherein the method comprises further a step of allowing the first user to select at least one of the items from the wish list for purchase thereof by the first user and proceed to “check-out” for such purchase.

8. The method of dedicated online retail shopping as set forth in claim 1, wherein the method comprises further a step of including twenty-four-hour concierge service to handle any issues related to customer service by the dedicated shopping.

9. The method of dedicated online retail shopping as set forth in claim 1, wherein the method comprises further a step of using the dedicated shopping in connection with services and funds.

10. A system for dedicated online retail shopping, the system providing a first user of the dedicated shopping an option of shopping for at least one gift for a second user of the dedicated shopping from at least one online retail store and comprising:
a client computer system; and
a server computer system in communication with the client computer system over a computer network, wherein:
the online retail store is provided capability of accessing a primary shopping website and joining the dedicated shopping as an affiliated store;
the second user is provided capability of accessing and joining the dedicated shopping, later accessing the website, directly linking to the affiliated store that carries items desired by the second user, and posting a wish list of at least one item desired by the second user as a gift on the website;
the first user is provided capability of accessing and joining the dedicated shopping, later accessing the website, and selectively extracting the wish list and information about the desired gift from the website;
the affiliated store is allowed to directly fulfill the gifting;
the second user is provided capability of directly linking to the affiliated store, selecting the gift from the website, and associating the gift with a future date of delivery thereof to the first user;
at least one of the information, delivery date, any special occasion, and delivery data is stored into a database;
payment for the gift is secured; and
the gift is delivered to the second user either of by and on the delivery date.

11. The system of dedicated online retail shopping as set forth in claim 10, wherein the second user is allowed to join the dedicated shopping by logging into the website to create a protected account of the second user for the dedicated shopping.

12. The system of dedicated online retail shopping as set forth in claim 10, wherein the second user is allowed to refer at least one third party to join the dedicated shopping such that when the third party joins and makes at least one purchase using the dedicated shopping, the second user receives at least one of “points” redeemable toward purchase of at least one of the items and a cash gift toward a goal.

13. The system of dedicated online retail shopping as set forth in claim 10, wherein the second user is allowed to add at least one item desired by the second user to the wish list.

14. The system of dedicated online retail shopping as set forth in claim 10, wherein the dedicated shopping is linked to at least one social-media site to which the second user can post a link to the wish list.

15. The system of dedicated online retail shopping as set forth in claim 10, wherein the first user is allowed to access the wish list through use by the first user of a predetermined means of identification of the second user.

16. The system of dedicated online retail shopping as set forth in claim 10, wherein the first user is allowed to select at least one of the items from the wish list for purchase thereof by the first user and proceed to “check-out” for such purchase.

17. The system of dedicated online retail shopping as set forth in claim 10, wherein the system comprises also twenty-four-hour concierge service to handle any issues related to customer service by the dedicated shopping.

18. The system of dedicated online retail shopping as set forth in claim 10, wherein the dedicated shopping is used in connection with services and funds.
